(19) United States
(12) Patent Application Publication
(10) Pub. No.: US 2020/0401949 A1
(43) Pub. Date: Dec. 24, 2020

(54) OPTIMIZING MACHINE LEARNED MODELS BASED ON DWELL TIME OF NETWORKED-TRANSMITTED CONTENT ITEMS

(71) Applicant: Microsoft Technology Licensing, LLC, Redmond, WA (US)

(72) Inventors: Siddharth Dangi, Palo Alto, CA (US); Manas Somaiya, Sunnyvale, CA (US); Ying Xuan, Sunnyvale, CA (US); Bonnie Barrilleaux, San Francisco, CA (US)

(21) Appl. No.: 16/450,478

(22) Filed: Jun. 24, 2019

(51) Int. Cl. G06N 20/20

(52) U.S. Cl. CPC G06N 20/20

(57) ABSTRACT

Techniques for optimizing machine-learned models based on dwell time of network-transmitted content items are provided. In one technique, impression data and selection data are used train a selection prediction model. For each impression, a dwell time associated with that impression is determined and compared to a skip time. If the dwell time is less than the skip time, then a first training label that indicates that the impression is skipped is associated with the impression. If the dwell time is greater than the skip time, then a second training label that indicates that the impression is not skipped is associated with the impression. These training labels are used to train a skip prediction model. The selection prediction model and the skip prediction model are used in a content item selection event to generate a score for each candidate content item. The scores are used to select a content item.

### TECHNICAL FIELD

The present disclosure relates to machine learning in selection of network-transmitted content items and, more particularly to, optimizing machine-learned models based on dwell time of entities to which the network-transmitted content items are presented.

### BACKGROUND

Machine learning is the scientific study of algorithms and statistical models that computer systems use to effectively perform a specific task without using explicit instructions, relying on patterns and inference instead. Machine learning algorithms build a mathematical model based on sample data, known as “training data”, in order to make predictions or decisions without being explicitly programmed to perform the task. Machine learning algorithms are used in a wide variety of applications, such as email filtering, and computer vision, where it is infeasible to develop an algorithm of specific instructions for performing the task.

Another application in which machine learning algorithms or techniques are used is generating a ranking model for ranking content items in order to optimize for one or more objectives, such as a user clicking a content item, a user viewing video within a content item, a user performing a viral action with respect to a content item (e.g., clicking a like or share button associated with the content item), and a user performing one or more downstream actions after viewing a content item.

Example ranking models take into account click actions and viral actions, which reflect active consumption. However, relying primarily on click actions and viral actions to train a ranking model has a number of disadvantages. One disadvantage is that click/viral actions are relatively rare occurrences, especially for passive users of an online service or content platform. Another disadvantage is that click/viral actions are binary and, thus, do not reflect other value that users may have derived from content items that were not clicked, for example. Lastly, click/viral actions are not always reliable measures of satisfaction. For example, even though users might have clicked on a content item, many times such users return quickly a page or view that included the content item, indicating that the click may have been inadvertent or unintentional. Recording such clicks as positive instances of user interest will result in training any future ranking model using inaccurate data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram of an example system for leveraging dwell time in machine-learning models, in an embodiment;

FIGS. 3A-3B are graph of various probabilities of user selection over dwell time;

FIGS. 4A-4B is a flow diagram that depicts an example process for incorporating a skip model into a content item ranking model, in an embodiment;

FIG. 5 is a flow diagram that depicts an example process for modifying training instance based on dwell time, in an embodiment;

FIG. 6 is a flow diagram that depicts an example process for modifying weights of positive training instances, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for leveraging dwell time in optimizing machine-learned models are provided. In one approach, content ranking and selection techniques presumed that user actions relative to specific content items represent value to the end-user. Under this paradigm, because actions are relatively rare, value to users is only measurable for a relatively small set of content items. In contrast, in ranking and selection techniques described herein, time spent viewing content items represents value to the user. As a result, value can be measured for virtually every presented content item.

In one technique, a dwell time is defined based on tracking data that indicates when a content item is presented to a user and when the content item ceases to be presented to the user. Probability of user action (e.g., click, like, share, comment) is computed over time. A skip time (indicating a period of time from presentation of a content item) may be determined such that the probability of user action remains near zero. Thus, dwell time is used as a negative signal; if a user spends a relatively short amount of time viewing a content item, then it is presumed the user did not gain value from viewing the content item.

In a related technique, the skip time is used to label training instances of impressions to indicate whether users “skipped” the corresponding content items. In another related technique, dwell time is used to modify the weight of positive training instances in order to promote content items on which users spend more time and, therefore, presumably find more useful.

Embodiments improve computer technology by optimizing which content items are presented to users. A technical problem is optimizing which content items are selected for presentation while taking into account multiple objectives. Past approaches primarily relied on clicks and conversions as signals of value and, thus, optimizing for those metrics. However, users find value in content that they do not click. A technical solution is to determine a skip time such that any amount of dwell time less than the skip time indicates that the user did not find value in the content item. A machine-learned model may be trained based on attributes of users and attributes of content items that were presented to the users to determine which attributes are relevant in predicting whether another user will skip a candidate content item.

### System Overview

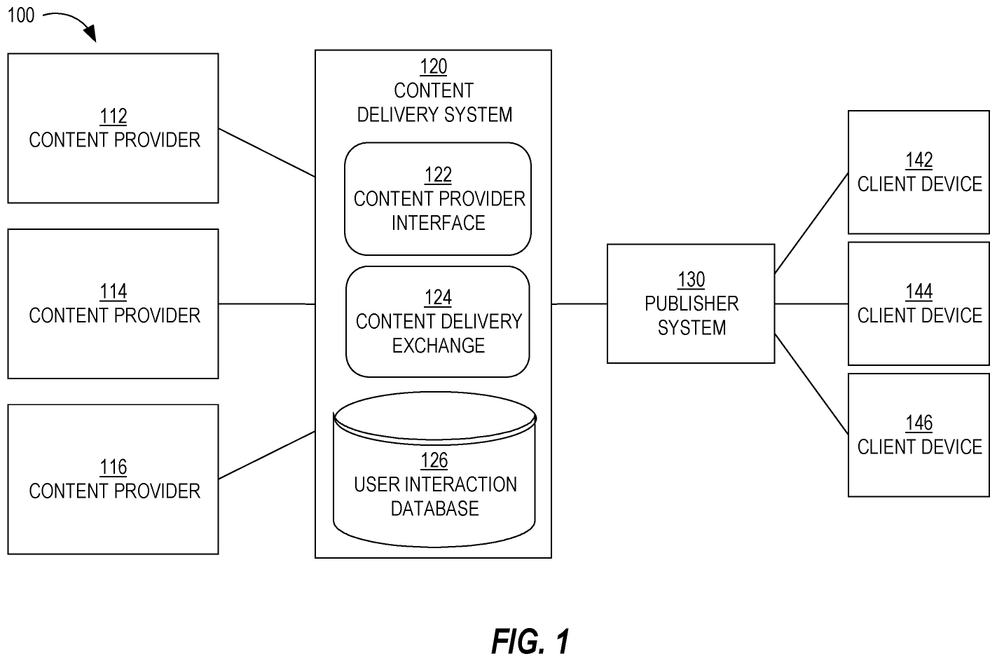

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a Local Area Network (LAN), Wide Area Network (WAN), Ethernet or the Internet, or one or more terrestrial, satellite or wireless links) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Another example of a content provider is a user or member of an online service, such as a social network service. Thus, users who are registered with publisher system 130 may create and upload content to content delivery system 120. Thus, content delivery system 120 may distribute content provided by enterprises and individuals.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones. An example of an application that communicates with content delivery system 120 and/or publisher system 130 over a computer network (not depicted) includes a native application (e.g., a “mobile app”) that is installed and executed on a local computing device and that is configured to communicate with publisher system 130 over a computer network. Another example of an application is a web application that is downloaded from publisher system 130 and that executes within a web browser running on a computing device.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or a interaction data set. Thus, content delivery system 120 may include a user interaction database 128. Logging such events allows content delivery system 120 to track how well different content items and/or campaigns perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery campaign (or multiple content items from the same content delivery campaign), content delivery system 120 may calculate a user interaction rate for the content delivery campaign. Additionally, from interaction data items and impression data items associated with a content provider (or content items from different content delivery campaigns initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

### System Overview for Leveraging Dwell Time

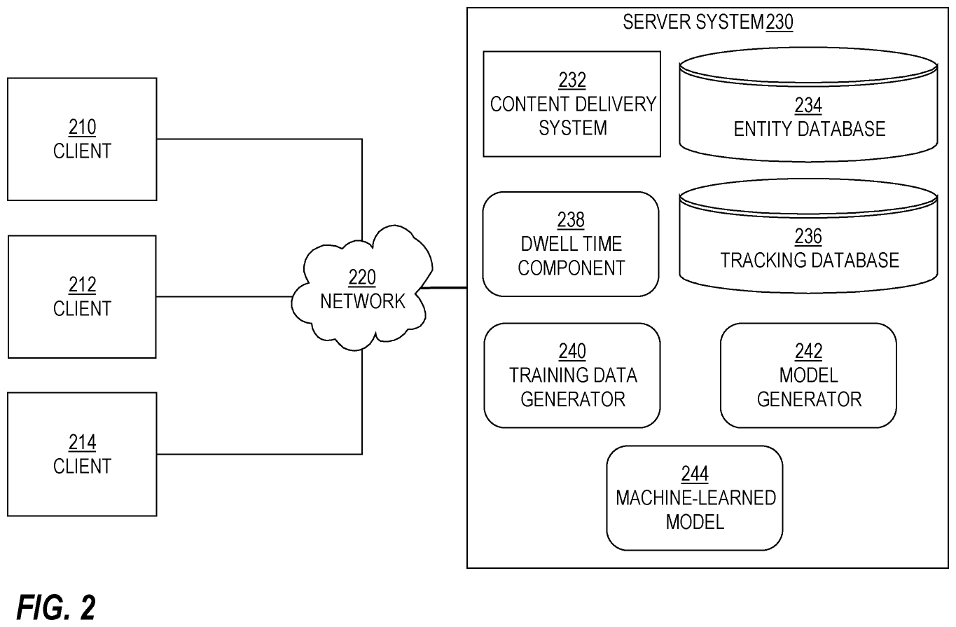

FIG. 2 is a block diagram of an example system 200 for leveraging dwell time in machine-learning models, in an embodiment. System 200 includes clients 210-214, network 220, and server system 230.

Each of clients 210-214 is an application or computing device that is configured to communicate with server system 230 over network 220. Examples of computing devices include a laptop computer, a tablet computer, a smartphone, a desktop computer, and a personal digital assistant (PDA). An example of an application includes a native application (e.g., a “mobile app”) that is installed and executed on a local computing device and that is configured to communicate with server system 230 over network 220. Another example of an application is a web application that is downloaded from server system 230 and that executes within a web browser running on a computing device. Each of clients 210-214 may be implemented in hardware, software, or a combination of hardware and software. Although only three clients 210-214 are depicted, system 200 may include many more clients that interact with server system 130 over network 220.

Network 220 may be implemented on any medium or mechanism that provides for the exchange of data between clients 210-214 and server system 230. Examples of network 220 include, without limitation, a network such as a LAN, WAN, Ethernet or the Internet, or one or more terrestrial, satellite or wireless links.

Server system 230 includes a content delivery system 232 (e.g., content delivery system 120), an entity database 234, tracking database 236, a dwell time component 238, a training data generator 240, a model generator 242, and a machine-learned model 244. Each of dwell time component 238, training data generator 240, and model generator 242 may be implemented in software, hardware, or any combination of software and hardware.

Although depicted as a single element, server system 230 may comprise multiple computing elements and devices, connected in a local network or distributed regionally or globally across many networks, such as the Internet. Thus, server system 230 may comprise multiple computing elements other than the depicted elements. Additionally, although only a machine-learned model 244 is depicted, server system 230 may include multiple machine-learned models that generate scores for content items. For example, multiple machine-learned models may generate different score for the same set of content items or content delivery campaigns.

### Machine Learning

Machine-learned model 244 is automatically trained using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users. The statistical model is trained based on multiple attributes. In machine learning parlance, such attributes are referred to as “features.” To generate and train a statistical prediction model, a set of features is specified and a set of training data is identified.

Embodiments are not limited to any particular machine learning technique for training a model. Example machine learning techniques include linear regression, logistic regression, random forests, naive Bayes, and Support Vector Machines (SVMs). Advantages that machine-learned models have over handcrafted rule-based models include the ability of machine-learned models to output a probability (as opposed to a number that might not be translatable to a probability), the ability of machine-learned models to capture non-linear correlations between features, and the reduction in bias in determining weights for different features.

A machine-learned model may output different types of data or values, depending on the input features and the training data. For example, if a user-content item pair is being scored, then input to machine-learned model 244 may comprise multiple feature values of the content item and multiple feature values of the user. Example user-related features includes job title, industry, job function, employer, academic degrees, geographical location, skills. Example content item-related features includes identity of the content provider that initiated the corresponding campaign, industry, display characteristics of the content item, classification of subject matter of the content item, etc. Likewise, a training instance used to train machine-learned model 244 will include the same types of features along with a label that indicates a dependent variable, such as whether the user selected (e.g., clicked), “skipped,” “bounced,” or performed a viral action (e.g., liked, shared) with respect to the content item.

In order to generate the training data, information about each entity is analyzed to compute the different feature values. In an example where machine-learned model 244 scores user-content item pairs, each training instance corresponds to a different user-content item pair. The dependent variable (or label) of each training instance may be whether the user performed some action relative to the content item or whether the user spent a threshold amount of time viewing the content item. Thus, the label is either a 1 or a 0. In a non-binary scenario, the label may be unbounded. For example, the dependent variable is dwell time, in which case the label can be any value greater than 0.

Initially, the number of features that are considered for training may be significant. After training machine-learned model 244 and validating machine-learned model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future machine-learned models and making predictions.

### Skipped Content Items and Click Bounces

The time that a content item is presented to a user in a visible area of a screen of a computing device is referred to herein as the “dwell time.” Though a user might not ever look at a content item that is visible (e.g., while scrolling through a content item feed or while looking at another portion of a web page that contains the content item), it is presumed that the user viewed the content item. A short dwell time may be used to determine whether a user has effectively “skipped” (or ignored) a content item. The content item may be an item that is presented (on a computer screen) in a scrollable content item feed (comprising multiple content items) or an item that is presented (on a computer screen) in response to the user selecting another content item. The former is referred to herein as a “skipped content item” and the latter is referred to as a “click bounce.” Thus, in a skipped content item scenario where there is a short dwell time on a content item feed, a user is presented a content item in a content item feed for a short period of time before scrolling past the content item to view a subsequent content item. For example, for content item A, a user viewed content item A for 0.8 seconds and did not interact with content item A in any way, while for content item B, a user viewed content item B for 12 seconds, yet did not interact with content item B in any way. Without taking into account the time that content items are presented to the respective users, training data labels for both situations would be negative. Thus, both situations are treated the same, even though content item B is actually more relevant to the user.

In a click bounce scenario where there is a short dwell time after a click, a user clicks on a first content item in a content item feed, causing a second content item (e.g., a video or article) to be presented, but the user only reads the second content item for a short time (if at all) and then returns to the content item feed without taking any other online action. For example, for article A, a user reads article A for 1.8 seconds and did not interact with article A in any way, while for article B, a user reads article B for 1 minute, yet did not interact with article B in any way. Without taking into account the time that content items are presented to the respective users, training data labels for both situations would be positive (as a result of click to view the respective articles), even though article B is likely more relevant.

### Calculating Dwell Time

The dwell time of a content item may be calculated by subtracting (1) the time at which the content item becomes visible from (2) the time at which the content item is no longer visible. A “visible” content item may be one where the entire content items is not visible, such as 50% of the content item being visible or even just a single pixel (or single row of pixels) of the content item being visible. Alternatively, a “visible” content is one that must be 100% visible; otherwise it is considered no longer visible.

A client application, whether a native application or a web application, that presents content items detects, for each content item, how much of a content item is presented. The client application generates a visible event for a content item when the content item is presented (e.g., at least 50% or 100%) and generates a non-visible event for the content item when the content item is not presented (e.g., at least 40%). Such events include a timestamp and a content item identifier that uniquely identifies, to content delivery system, the corresponding content item. Such events may also indicate a client identifier (e.g., a cookie identifier) or a device identifier that uniquely identifies the client device or client session.

### Determining a Skip Time

A skip rate may be defined as the number of skipped content items relative to the number of presented content items. In order to determine whether a content item has been skipped, a skip time is determined. The skip time may be determined by server system 230.

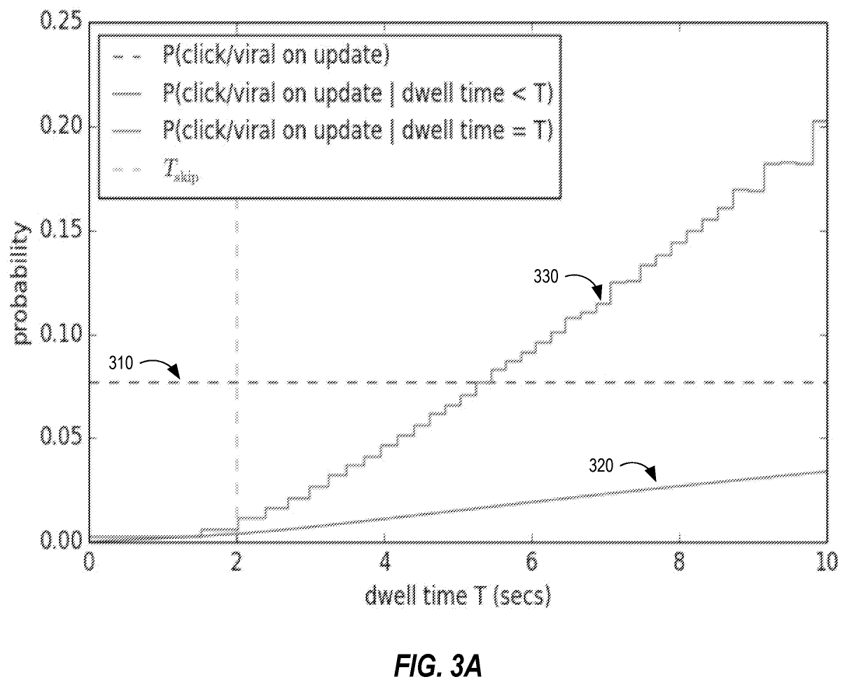

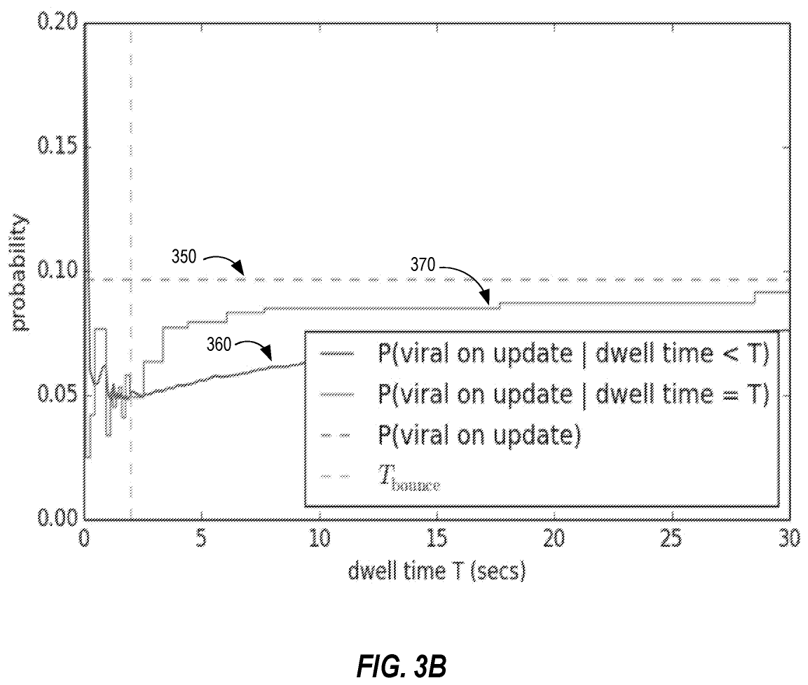

In an embodiment, a skip time is determined by analyzing probabilities of user selections over dwell time. FIG. 3A is a graph of various probabilities of user selection over dwell time. The horizontal dotted line 310 indicates a probability of a user selection regardless of dwell time. Such a probability may be calculated by dividing the number of user selections of content items (over a period of time) by the number of content item impressions (over the same period of time), some of which impressions may be for the same content item.

The slowly rising line 320 in the graph indicates the probability of user selection given that the dwell time is less than a particular time T. The more rapidly rising line 330 in the graph (i.e., P(click/viral dwelltime=T)) indicates the probability of a user selection given that the dwell time equals a particular time T.

One way to estimate the probability of P(click/viral dwelltime=T) is with the following formula, which is an approximation of this value using Bayes' Theorem and empirical CDFs:

$$P ( click / viral \vert dwelltime = T ) \approx P ( click / viral \vert dwelltime ∈ [ T - δ , T + δ ] ) = \frac{P ( dwelltime ∈ [ T - δ , T + δ ] [ click / viral ] ) \cdot P ( click / viral )}{P ( dwelltime ∈ [ T - δ , T + δ ] )} = \frac{\begin{matrix}[ P ( dwelltime < T + δ \vert click / viral ) - \\ P ( dwelltime < T - δ \vert click / viral ) ] \cdot P ( click / viral )\end{matrix}}{P ( dwelltime ∈ [ T - δ , T + δ ] )}$$

where P(dwelltime<T|click/viral) is the CDF (cumulative distribution function) of dwell time on a content item, given that there was a click or viral action.

The skip time may be determined for a time T where the probability of a user selection is still very small, such as below 0.01. Thus, the skip time may change over time, based on a history of impressions and user interactions. Also, the probability threshold (0.02 in this example) that is used to determine the skip time may be fixed, manually tuned, or automatically tuned. For example, different probability thresholds may be used to determine different skip times. Different skip times may be used in one or more machine learning techniques described herein to train different ranking models. The different ranking models may be evaluated by testing the ranking models against validation data and/or in a production environment to determine which ranking model performs the best according to one or more metrics. The skip time associated with the best performing ranking model may be used solely or primarily (relative to other potential skip times) in the production environment.

In an embodiment, multiple skip times are determined and used in different situations. For example, different types of content items are associated with different skip times. As a specific example, content items that pertain to job postings may have a first skip time while content items that include video may have a second skip time that is different than the first dwell time. Other example types of content items include text postings from users of an online service (e.g., a social network service), advertisements, online learning course recommendations, etc.

As another example, different content delivery channels are associated with different skip times. As a specific example, content items that are presented through mobile devices may have a first skip time while content items that are presented on desktop computers may have a second skip time that is different than the first skip time.

As another example, different geographic locations are associated with different skip times. As a specific example, users in United States may have a first skip time while users in China may have a second skip time that is different than the first skip time.

As another example, specific users or groups of users are associated with different skip times. For example, users who visit a particular online service on a monthly basis are associated with a first skip time, users who visit the particular online service on a weekly basis are associated with a second skip time, users who visit a particular online service on a daily basis are associated with a third skip time.

### Determining a Bounce Time

A bounce rate may be defined as the number of click bounces relative to the number of selected content items. In order to determine whether a user has “bounced” when viewing a selected content item, a bounce time is determined.

In an embodiment, a bounce time is determined by analyzing probabilities of user selections of content items over dwell time. The user selection (or non-selection) tracked in this scenario is the user selection of a content item that is linked to by another content item that was selected by the same user. For example, a content item may include an excerpt from an online news article and a link to the news article. If a user selects (or clicks on) the content item, then the user's browser (or other client application) retrieves the news articles and renders its content on a display or screen of the user's computing device. The time that the news article is presented to the user may be tracked to in order to calculate the probability of user selecting (e.g., “liking”) linked-to content items. The time of such presentation may be inferred if the user performs an action that causes the originally-selected content item to be displayed. For example, a client application determines a time of the user's selection of the original content item and a time of presentation of a subsequent content item in a content item feed that include both content items.

A user selection of a linked-to content item may be a viral action, such as selecting a “like” or “share” button adjacent to the content item or commenting on the content item.

FIG. 3B is a graph of various probabilities of user selections over dwell time. The horizontal dotted line 350 indicates a probability of a user selection regardless of dwell time. Such a probability may be calculated by dividing the number of user selections of linked-to content items (over a period of time) by the number of user selections of impressions of the linked-to content items (over the same period of time), some of which impressions may be for the same content item.

The lower rising line 360 in the graph indicates the probability of user selection given that the dwell time is less than a particular time T. The higher rising line 370 in the graph indicates the probability of a user selection given that the dwell time equals a particular time T.

The bounce time may be determined for a time T where the probability of a user selection is still very small, such as below 0.05. Thus, the bounce time may change over time, based on a history of impressions of linked-to content items and user interactions with linked-to content items. Also, the probability threshold that is used to determine the bounce time may be fixed, manually tuned, or automatically tuned. For example, different probability thresholds may be used to determine different bounce times. Different bounce times may be used in one or more machine learning techniques described herein to train different ranking models. The different ranking models may be evaluated by testing the ranking models against validation data and/or in a production environment to determine which ranking model performs the best according to one or more metrics. The bounce time associated with the best performing ranking model may be used solely or primarily (relative to other potential skip times) in the production environment.

In an embodiment, similar to skip times described herein, multiple bounce times are determined and used in different situations.

### Uses of Time

A dwell time and/or skip time may be used in a machine learning context in one or more ways. For example, a new machine-learned model related to skip time is incorporated into an existing ranking function/model. As another example, skip time may be used to determine labels of training instances for existing and/or new machine-learned models, such as a click prediction model. As another example, dwell time may be used to modify the weight of positive training instances in order to promote content items on which users spend more time and, therefore, presumably find more useful. Each of these example ways in which a dwell time or a skip time may be utilized in a machine learning context is described in more detail herein.

### Incorporating a Skip Model into a Content Item Ranking Model

In an embodiment, a skip model is generated and incorporated into a content item ranking model that takes, as input, output of the skip model. Thus, the skip model is an input prediction model that acts as a negative input to the content item ranking model, whereas other input prediction models, such as a click prediction model, act as a positive input to the content item ranking model.

An example content item ranking model may be represented in the following utility function:

core=α*P(click)+(1−α)*Σ(P(action))+

(1−α)β*Σ(P(action)*E[downstream clicks/viral|action])+

λ*P(viral)*E[value to creator|viral])

where action ϵ {like, share, comment}, “α*P(click)+(1−α)Σ(P(action))” represents a value to the viewer, “(1−α)β*Σ(P(action)*E[downstream clicks/viral|action])” represents a value to the viewer's network (e.g., of “friends” in an online social network), and “λ*P(viral)*E[value to creator|viral])” represents a value to the creator of the candidate content item that may be presented to the viewer. P(click) is a click model that predicts a likelihood of a click given a particular user and a particular candidate content item. P(action) is an action model that predicts a likelihood of one or more types of actions (other than a click) given a particular user and a particular candidate content item. E[downstream clicks/viral action] is a model that estimates a number of downstream clicks and/or virals given a particular action performed by a particular user.

Adding a skip model to this utility function may result in the following:

$$Score = α * P ( click ) + ( 1 - α ) * \sum ( P ( action ) ) - γ P ( skip ) + ( 1 - α ) β * \sum ( P ( action ) * E [ downstream clicks / viral \vert action ] ) + λ * P ( viral ) * E [ value to creator \vert viral ] )$$

where “P(skip)” represents the skip model, γ is a weight that is applied to output of the skip model, and the subtraction operation represents that skipping a content item is a negative utility. In other words, the higher the probability of a skip, the higher the negative utility will be.

Features of P(click), P(skip), P(action), and P(viral) may be the same or different. Example features include user-specific features, content item-specific features, cross type features, and contextual features.

Examples of user-specific features (of the viewer) include job title, job function, industry, skills, current employer, past employers, employment status, geographic location, academic institutions attended, and academic degrees earned.

Examples of content item-specific features include identity of the creator(s) of the content item, content item type (e.g., post, job posting, article, advertisement, image, video), keywords, and category.

Examples of contextual features include time of day, day of week, device type (e.g., mobile, laptop, desktop, wearable device), operation system, application type (e.g., web application or native application), and geographic location.

Examples of cross type features include whether the viewer and content item share certain features in common (e.g., industry), whether the viewer and creator share certain features in common (e.g., geography, job title, industry), whether the viewer and creator are connected in an online social network (or are at least within N degrees of separation), and a number of shared connections between the viewer and creator.

Highly predictive features of a skip prediction model may include (global or member-specific) historical skip rates for different types of content items. Similarly, historical skip rates for content items authored by (or interacted with by) particular users.

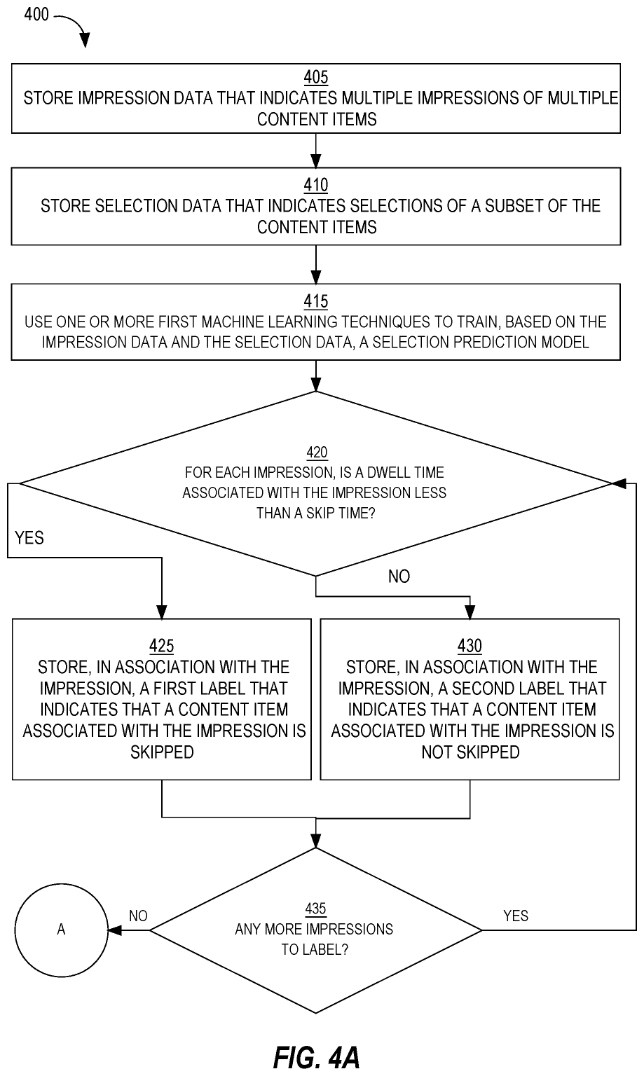

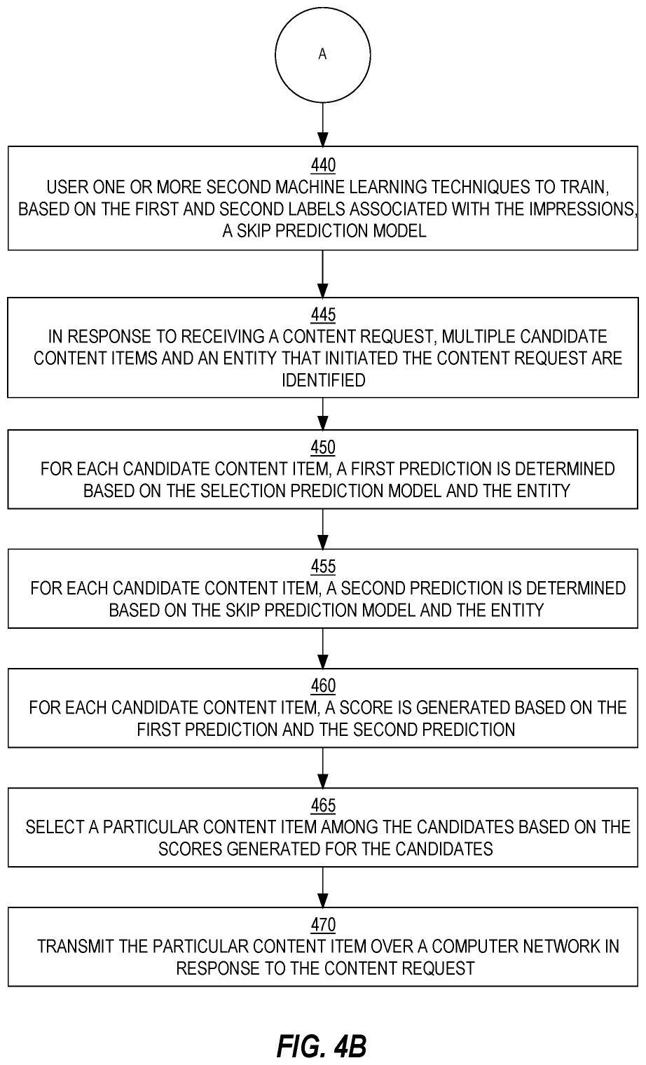

FIGS. 4A-4B is a flow diagram that depicts an example process 400 for incorporating a skip model into a content item ranking model, in an embodiment. Process 400 may be performed by different components of server system 230.

At block 405, impression data that indicates multiple impressions of multiple content items is stored. The impression data comprises multiple impression events, each corresponding to a different impression. An impression event may be received from a client device that presented a content item corresponding to the impression or from a content item exchange that ultimately provided the content item to the client device. The impression data may be stored in tracking database 236.

At block 410, selection data that indicates selections of a subset of the content items is stored. The selection data comprises multiple selection events, each corresponding to a different selection. A selection event may be received from a client device that received the corresponding selection or from a content item exchange that ultimately provided the content item to the client device. The selection data may be stored in tracking database 236.

At block 415, one or more first machine learning techniques are used to train, based on the impression data and the selection data, a selection prediction model. Block 415 may be performed by model generator 242. Machine-learned model 244 is an example of the selection prediction model. Block 415 may involve generating training instances (e.g., by training data generator 240) based on the impression data and the selection data, each training instance corresponding to an impression and indicating whether there is a corresponding selection of a content item of the impression. The feature values of each training instance may be retrieved from internal or external sources, such as a profile data source that comprises profile data of multiple users (e.g., of an online service) and a campaign data source that comprises data about multiple content delivery campaigns. The selection prediction model is then trained based on the generated training instances.

At block 420, it is determined whether, for each impression, a dwell time associated with the impression is less than a particular threshold (e.g., two seconds). The value of particular threshold (or skip time) may be determined manually or automatically, using techniques described herein. Block 420 may be performed by training data generator 240 that reads data generated by dwell time component 238 that analyzes impression data to determine how long each content item was presented. If the result of block 420 is in the affirmative, then process 400 proceeds to block 425; otherwise, process 400 proceeds to block 430.

At block 425, a first label that indicates that a content item associated with the impression is skipped is stored in association with the impression. Block 425 may involve generating a training instance that includes the first label. Block 425 may be performed by training data generator 240.

At block 430, a second label that indicates that a content item associated with the impression is not skipped is stored in association with the impression. Block 430 may involve generating a training instance that includes the second label. Block 430 may be performed by training data generator 240.

At block 435, it is determined whether there are any more impressions to label. The impressions that are labeled in this manner may be the same impressions that are used to train the selection prediction model, may be different than the impressions used to train the selection prediction model, or may overlap with the impressions used to train the selection prediction model.

At block 440, one or more second machine learning techniques are used to train, based on the first and second labels associated with the impressions, a skip prediction model. If machine-learned model 244 is an example of the selection prediction model, then server system 230 includes another machine-learned model, not depicted. The one or more machine learning techniques may be the same or different than the machine learning techniques used to train the selection prediction model. For example, logistic regression may be used to train the selection prediction model and gradient boosting may be used to train the skip prediction model. Block 440 may be performed by model generator 242.

At block 445, in response to receiving a content request, multiple candidate content items and an entity that initiated the content request are identified. For example, each content delivery campaign may include a list of entity identifiers of entities (e.g., users) that satisfy targeting criteria associated with the campaign. At the time of the content request, an entity identifier included in the content request (or identified based on content within the content request, such as a cookie or IP address) is used to identify all content delivery campaigns that include the entity identifier in their respective targeting list. Each content delivery campaign comprises at least one content item, potentially more. Such content items become the candidate content items. Blocks 445-470 may be performed by content delivery system 232 or content delivery exchange 124.

At block 450, for each candidate content item, a first prediction is determined based on the selection prediction model and the entity. Block 450 may involve retrieving profile data about the entity (e.g., from entity database 234) and retrieving content item data about the candidate content item (e.g., from entity database 234 or a separate campaign database, not depicted). (The content item data may include information about the corresponding content delivery campaign as a whole.) Such retrieved data (or a portion thereof) is used as feature values in the selection prediction model, which generates a score, representing a prediction. Block 450 may involve leveraging machine-learned model 244 to produce the first prediction.

At block 455, for each candidate content item, a second prediction is determined based on the skip prediction model and the entity. Block 455 may involve identifying the same/different profile data about the entity and/or the same/different content item data about the candidate content item. Such identified data (or a portion thereof) is used as feature values in the skip prediction model, which generates a score, representing a prediction.

At block 460, for each candidate content item, a score is generated based on the first prediction and the second prediction. Block 460 may involve inserting the first prediction and the second prediction into a scoring function (that is part of the content item ranking model), that calculates a single score based on the respective inputs. The score may be used to rank the candidate content item relative to other candidate content items.

At block 465, a particular content item from among the candidate content items is selected based on the scores generated for the candidate content items. Block 465 may involve selection the top N content items based on the scores, where N is a positive integer.

At block 470, the particular content item is transmitted over a computer network in response to the content request. Block 470 may involve generating an HTTP response and including, in the response, data items that make up the particular content item (or references (e.g., URLs) to the data items). For example, a client device that receives the response will display content included in the response and/or retrieve content from a remote source based on any references.

In an embodiment, a bounce prediction model is incorporated into a content item ranking model in a similar fashion as the skip prediction model. For example, utility function described previously may include a bounce prediction model instead of, or in addition to, a skip prediction model. The bounce prediction model, like the skip prediction model, would have a negative effect on the final score. In other words, the higher the likelihood of the predicted bounce, the lower the score, all else being equal. Conversely, the lower the likelihood of the predicted bounce, the higher the score, all else being equal.

### Dwell Time Models

In an embodiment, one or more dwell time models are trained using one or more machine learning techniques. Instead of predicting a binary outcome of whether a user will skip a content item, a dwell time model predicts an amount of time, such as an amount of time the user is expected to spend viewing a content item (e.g., E[dwell time on content item]) or an amount of time the user is expected to spending viewing content to which the content item is linked after selecting (e.g., clicking) the content item (e.g., E[dwell time after click]). Thus, a dwell time model predicts a positive real number; thus, a dwell time model may be linear, log-linear regression, or tree regression models. Features of a dwell time model may include at least some of the same features as a skip prediction model and/or a selection prediction model.

In a related embodiment, a utility function takes into account a skip prediction model and one or more dwell time models when generating a score for a content item. Thus, even though the likelihood of a user skipping a content item is relatively high (as indicated by a skip prediction model), a prediction of the time that the user will spend viewing content linked to by the content item if the user clicks the content item may be relatively high, resulting in a relatively high score.

In a related embodiment, a utility function for generating a score for a content item includes one or more dwell time (E[dwell time]) models but does not include a skip prediction model or bounce prediction model.

### Modifying Training Labels Based on Dwell Time

In an embodiment, dwell time is used to modify labels for training instances, which are used to train a machine-learned model that scores candidate content items, which scores may be used to determine which candidate content items will be presented to a user and, optionally, an order in which the candidate content items will be presented.

Each training instance includes feature values for features upon which the machine-learned model is based. Each training instance includes one or more labels, each label corresponding to a prediction or output type of the machine-learned model that is trained based on the training instances. For example, if the model is a click prediction model, then a training instance may include feature values of a content item, feature values of a user to which the content item was presented, feature values of a creator/author/uploader of the content item, and a label indicating whether the user selected (e.g., clicked on or “liked”) the content item. A positive training instance is one where the label indicates that the user selected the content item, while a negative training instance is one where the label indicates that the user did not select the content item. A positive training instance is based on (1) an impression event that identifies the content item and the user and (2) a click event that also identifies the content item and the user. Each event may include timestamp data that may be used to ensure that the click event occurred after the impression event. In contrast, a negative training instance is based (1) only on an impression event that identifies the content item and the user and (2) the fact that there is no corresponding selection event that identifies both the content item and the user (and, optionally, that is temporally after the impression event within a certain period of time).

In an embodiment, if a dwell time of a selected content item is less than a bounce time, then a training instance for the user selection is given a negative label, causing the training instance to be a negative training instance. The situation where the dwell time is less than the bounce time indicates that it was likely that the selection of the corresponding content item was unintentional or accidental. If dwell time was not a factor in labeling the training instance, then the training instance would be a positive training instance, even though the selection was likely inadvertent or accidental. The training instances are used to train a machine-learned model for predicting selections (e.g., clicks) or viral actions, such as likes, shares, or comments.

In a related embodiment, because different users or groups of users may be associated with different bounce times, different training instances based on those different users/groups are labeled based on their respective bounce times. For example, the training data used to train a particular machine-learned model may include (1) a first training instance based on a first content item presented to a first user and (2) a second training instance based on a second content item presented to a second user. In both instances, a bounce of the content item occurred within 2.3 seconds of content linked to by the selected content item being presented to the respective users. However, the first user is associated with a bounce time of 2.1 and the second user is associated with a bounce time of 2.5 seconds. Therefore, the first training instance is associated with a positive label (indicating that user selection of the first content item was likely intentional) and the second training instance is associated with a negative label (indicating that user selection of the second content item was likely unintentional).

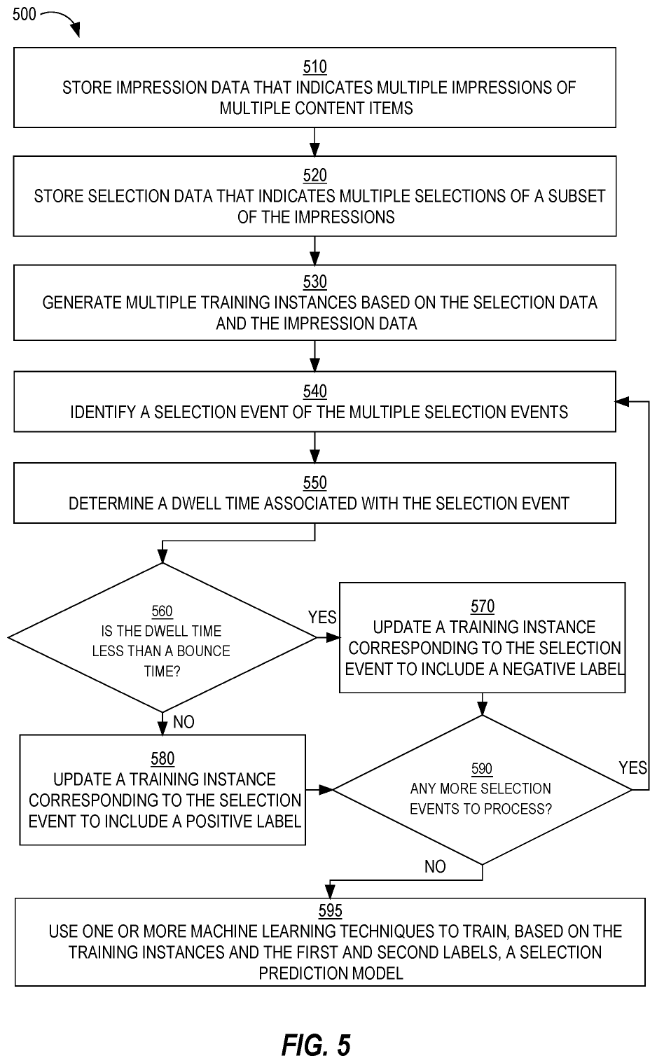

FIG. 5 is a flow diagram that depicts an example process 500 for modifying training instance based on dwell time, in an embodiment. Process 500 may be performed by one or more components of server system 230.

At block 510, impression data that indicates multiple impressions of multiple content items is stored. Some content items may be impressed/presented multiple times. Thus, multiple of the impressions may be of the same content item. Block 510 may be performed in response to receiving tracking data from client devices (e.g., client devices 142-146). Each impression event received from a client device indicates a content item that was presented and a user/member to which the content item was presented, and includes timestamp information, such as a date and time of day, of when the content item was presented to the user/member. The impression data comprises multiple impression events received from multiple client devices. The impression data may be stored in tracking database 236.

At block 520, selection data that indicates multiple selections of a subset of the impressions is stored. The number of selections may be much fewer than the number of impressions. However, each of the content items that were impressed (some multiple times) may be indicated in the selection data. Block 520 may be performed in response to receiving tracking data from client devices (e.g., client devices 142-146). Each selection event received from a client device indicates a content item that was presented and a user/member to which the content item was presented, and includes timestamp information, such as a date and time of day, of when the content item was selected by the user/member. The selection data comprises multiple selection events received from multiple client devices. The selection data may be stored in tracking database 236.

At block 530, multiple training instances are generated based on the selection data and the impression data. Each training instance corresponds to an impression and includes data about (1) a content item that was presented and (2) a user to which the content item was presented. Block 530 may be performed by training data generator 240.

At block 540, a selection event of the multiple selection events is identified. Block 540 may be performed randomly or sequentially in order of time of selection. Blocks 540-590 may be performed by multiple processes or threads in parallel, ensuring that the same selection event is not processed twice by the same or different processes/threads.

At block 550, a dwell time associated with the selection event is determined. The dwell time may be based on a timestamp of the selection event (or of an event that indicates that content presented in response to selection of the corresponding content item) and a timestamp of a returning event (which indicates that the presented content is no longer presented to the corresponding user). Block 550 may be performed by training data generator 240 that reads dwell time data generated by dwell time component 238.

At block 560, it is determined whether the dwell time is less than a bounce time. If so, then process 500 proceeds to block 570; otherwise, process 500 proceeds to block 580. In an embodiment, different users/entities are associated with different bounce times. For example, if the dwell time for two users was 2.3 seconds, and the bounce time for a first user is 2.1 seconds and the bounce time for a second user is 2.5 seconds, then a result of block 560 for the first user would be in the negative and a result of block 560 for the second user would be in the affirmative.

At block 570, the training instance corresponding to the selection event is updated to include a negative label (e.g., ‘0’), which effectively indicates that the content item associated with the selection event was not selected by the user, even though the user actually selected the content item. Thus, the selection is treated as if it never happened.

At block 580, the training instance corresponding to the selection event is updated to include a positive label (e.g., ‘1’), which indicates that the content item associated with the selection event was selected by the user.

At block 590, it is determined whether there are any more selection events to process. If so, process 500 returns to block 540; otherwise, process 500 proceeds to block 595.

At block 595, one or more machine learning techniques are used to train, based on the training instances and the first and second labels, a selection (e.g., click) prediction model.

In an embodiment, because different users or groups of users may be associated with different skip times, different training instances based on those different users/groups are labeled based on their respective skip times. For example, the training data used to train a skip prediction model may include (1) a first training instance based on a first content item presented to a first user and (2) a second training instance based on a second content item presented to a second user. In both instances, dwell time of each user on the respective content item amounted to 2.3 seconds. However, the first user is associated with a skip time of 2.1 and the second user is associated with a skip time of 2.5 seconds. Therefore, the first training instance is associated with a negative label (indicating that the user did not skip the first content item) and the second training instance is associated with a positive label (indicating that the user skipped the second content item).

In an embodiment, dwell time is used to modify training instances to indicate that a content item was selected, even though the content item was not selected. For example, if a content item is in view for ten seconds and then the content item is no longer in view (e.g., as a result of the user scrolling through his/her content item feed), then a label for a training instance for that impression of the content item is positive, indicating that the user at least derived some value from the content item, due to the relatively long dwell time on the content item.

In a related embodiment, at least some training instances are associated with non-binary labels based on dwell time. For example, a first training instance corresponding to a user selection has a positive training label of 1, a second training instance corresponding to a non-selection with a dwell time greater than three seconds has a training label of 0.5, and a third training instance corresponding to a non-selection with a dwell time less than three seconds has a negative label (e.g., 0).

Each possible non-binary label value may be pre-assigned to a different range of dwell times, similar to an approach described above. For example, for impressions where there is no corresponding user selection, a dwell time between two seconds and six seconds is associated with a label of 0.3, a dwell time between six seconds and thirteen seconds is associated with a label of 0.5, and a dwell time over thirteen seconds has a weight of 0.8.

### Modify Weight of Training Instances Based on a Dwell Time

In an embodiment, dwell time is used to modify weights of training instances. For example, if a user spends a relatively long time (e.g., one minute) viewing content that is presented in response to user selection (e.g., click) of a content item, then a training instance based on the selection is weighted higher than if the user spent a relatively short time (e.g., five seconds) viewing the content. The dwell time viewing the content may be calculated by determining a difference between a first time when at least a portion of the content (e.g., an article, blog, video) was originally presented to the user and a second time when none of the content is visible to the user, such as if the user selects an option to return to a content item feed, which could generate an event that indicates that the content is no longer visible.

A weight of a training instance reflects an importance of the training instance in the process of training a machine-learned model. The higher a weight or importance that a training instance has, the more impact the training instance will have on the weights or coefficients of the machine-learned model during the training process. For example, a first training instance with a weight of two may be equivalent to have two instances of that first training instance in the training data. As another example, a first training instance with a weight of one may have twice the effect that a second training with a weight of 0.5 has on an eventual machine-learned model.

One way to incorporate dwell time in determining a weight of a training instance is to pre-assign different dwell periods with different weights. For example, a dwell time between two seconds and six seconds has a weight of 1.0, a dwell time between six seconds and thirteen seconds has a weight of 1.3, and a dwell time over thirteen seconds has a weight of 1.8.

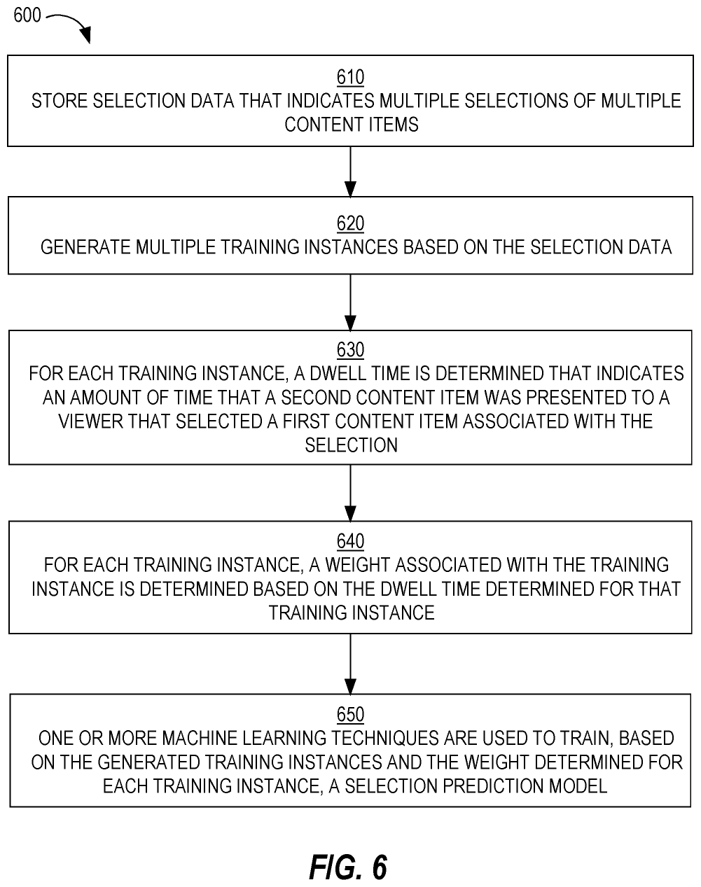

FIG. 6 is a flow diagram that depicts an example process 600 for modifying weights of positive training instances, in an embodiment. A similar process may be used to modify weights of negative training instances. Process 600 may be performed by one or more components of server system 230.

At block 610, selection data that indicates multiple selections of multiple content items is stored. Each selection indicates user selection of one of the content items. Each selection may correspond to a different selection event generated by a client device when a user of the client device selects a corresponding content item. The client device automatically transmits the selection event over a computer network to content delivery system 120. The selection data may be stored in tracking database 236.

At block 620, multiple training instances are generated based on the selections. Each training instance corresponds to a different selection of the multiple selections. Block 620 may be performed by training data generator 240.

At block 630, for each training instance, a dwell time is determined that indicates an amount of time that a second content item was presented to a viewer that selected a first content item associated with selection. Block 630 may be performed by training data generator 240 that reads dwell time data generated by dwell time component 238.

At block 640, for each training instance, a weight associated with the training instance is determined based on the dwell time determined for that training instance. Block 640 may involve looking up a dwell time-weight mapping that maps ranges of dwell times to specific weights. Alternatively, block 640 may involve inputting the dwell time into a (e.g., log) function that produces a score that is used as a weight. Block 640 may be performed by training data generator 240.

At block 650, one or more machine learning techniques are used to train, based on the generated training instances and the weight determined for each training instance, a selection prediction model. Block 650 may be performed by model generator 242.

In a related embodiment, for impressions that did not result in a user selection, dwell time is used to associate training instances for such impressions with a positive label, but a lower weight than a training instance that corresponds to a user selection. For example, a first training instance corresponding to a user selection has a positive training label (e.g., 1) and a weight of 1.0, a second training instance corresponding to a non-selection with a dwell time greater than eight seconds has a positive training label (e.g., 1) but a weight of 0.5 (indicating that the second training instance has a slightly positive effect on training a machine-learned model), and a third training instance corresponding to a non-selection with a dwell time less than eight seconds has a negative label (and no weight).

In a related embodiment, for impressions that did not result in a user selection, dwell time is used to associate training instances for such impressions with a negative label, but of varying weights depending on dwell time. For example, a user does not take any action on content item A, but spends four seconds viewing content item A, while the same or different user does not take any action on a content item B, but spends only two seconds viewing content item B. In this case, a training instance for content item B is more “negative” than a training instance for content item A. One way to reflect this to keep the labels for both training instances negative (e.g., 0), but include a higher weight for the training instance of content item B than the weight for the training instance of content item A.

In a related embodiment, instead of using weights, labels for at least some training instances are based on dwell time. For example, a first training instance corresponding to a user selection has a positive training label of 1, a second training instance corresponding to a non-selection with a dwell time greater than six seconds has a training label of 0.5, and a third training instance corresponding to a non-selection with a dwell time less than six seconds has a negative label (e.g., 0).

Each possible weight value may be pre-assigned to a different range of dwell times, similar to an approach described above. For example, for impressions where there is no corresponding user selection, a training instance with a dwell time between two seconds and six seconds is associated with a weight of 0.3, a training instance with a dwell time between six seconds and thirteen seconds is associated with a weight of 0.5, and training instance with a dwell time over thirteen seconds has a weight of 0.8.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

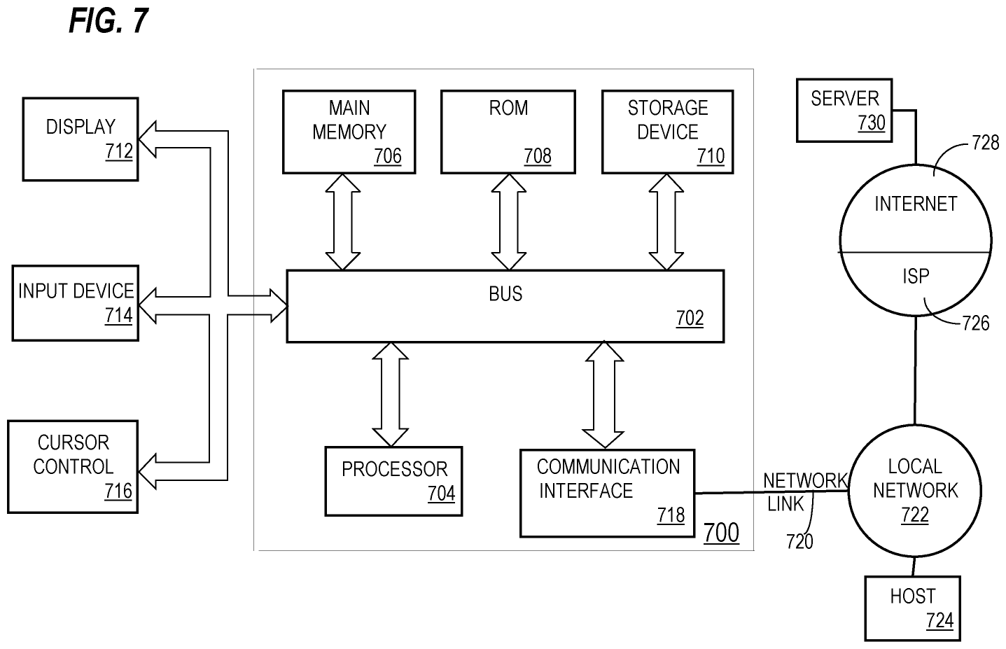

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing impression data that indicates a plurality of impressions of a plurality of content items;
storing selection data that indicates a plurality of selections of a subset of the plurality of content items;
using one or more first machine learning techniques to train, based on the impression data and the selection data, a selection prediction model;
for each impression of the plurality of impressions:
determining a dwell time associated with said each impression;
storing, in association with said each impression, a first label that indicates that a content item associated with said each impression is skipped if the dwell time is less than a skip time;
storing, in association with said each impression, a second label that indicates that the content item associated with said each impression is not skipped if the dwell time is greater than the skip time;
using one or more second machine learning techniques to train, based on the first and second labels associated with the plurality of impressions, a skip prediction model;
in response to receiving a content request:
identifying a plurality of candidate content items and an entity that initiated the content request;
for each candidate content item in the plurality of candidate content items:
determining a first prediction based on the selection prediction model and the entity;
determining a second prediction based on the skip prediction model and the entity;
generating a score based on the first prediction and the second prediction;
selecting a particular content item from among the plurality of candidate content items based on the score generated for each candidate content item in the plurality of candidate content items;
causing the particular content item to be transmitted over a computer network in response to the content request;
wherein the method is performed by one or more computing devices.

2. The method of claim 1, further comprising:
storing view data that indicates, for each content item of a second plurality of content items, an amount of time that said each content item has been presented to a viewer;
storing second selection data that indicates, for each content item of the second plurality of content items, an indication of whether the viewer, to which said each content item was presented, performed a particular action relative to said each content item;
generating a curve that represents a probability of the particular action relative to the second plurality of content items given a lapse of time from presentation of each of the second plurality of content items;
based on the curve, identifying the skip time that indicates a particular amount of time, below which it is presumed that future users, to which content items will be presented, have skipped the content items.

3. The method of claim 1, wherein the skip time is a first skip time, a first user is associated with the first skip time, and a second user is associated with a second skip time that is different than the first skip time.

4. The method of claim 1, further comprising:
storing viral selection data that indicates a plurality of viral selections of a second subset of the plurality of content items;
using one or more third machine learning techniques to train, based on the viral selection data, a viral prediction model;
for each candidate content item of the plurality of candidate content items:
generating a third prediction based on the viral prediction model;
generating an expected value, for a network of the entity, given a viral action;
generating a predicted value for the network of the entity based on the third prediction and the expected value;
wherein the score is further generated based on the predicted value.

5. The method of claim 4, further comprising:
for each candidate content item of the plurality of candidate content items:
generating a second expected value, for an author of said each candidate content item, given a viral action;
generating a second predicted value for the author of said each candidate content item based on the third prediction and the second expected value;
wherein the score is further generated based on the second predicted value.

6. The method of claim 1, further comprising:
for each selection in the plurality of selections:
determining a particular dwell time associated with said each selection;
storing, in association with said each selection, a third label that indicates that a content item associated with said each selection was not selected if the particular dwell time is less than a bounce time;
storing, in association with said each selection, a fourth label that indicates that the content item associated with said each impression was selected if the particular dwell time is greater than the bounce time;
wherein the selection prediction model is trained based on the third and fourth labels.

7. The method of claim 1, further comprising:
for each selection of the plurality of selections:
generating a training instance based on said each selection;
determining a particular dwell time that indicates an amount of time that a second content item was presented to a viewer that selected a first content item associated with said each selection;
determining, based on the particular dwell time, a weight associated with the training instance;
wherein the selection prediction model is trained based on the weight determined for each training instance.

8. A method comprising:
storing impression data that indicates a plurality of impressions of a plurality of content items;
storing selection data that indicates a plurality of selections of a subset of the plurality of content items;
generating a plurality of training instances based on the plurality of selections and the plurality of impressions;
for each selection in the plurality of selections:
determining a dwell time associated with said each selection;
storing, in association with a training instance, of the plurality of training instances, corresponding to said each selection, a first label that indicates that a content item, associated with said each selection, that was selected by an entity was not selected if the dwell time is less than a bounce time;
storing, in association with the training instance corresponding to said each selection, a second label that indicates that the content item associated with said each impression was selected if the dwell time is greater than the bounce time;
using one or more first machine learning techniques to train, based on the plurality of training instances and the first and second labels, a selection prediction model;
wherein the method is performed by one or more computing devices.

9. The method of claim 8, further comprising:
identifying a particular impression of the plurality of impressions that is not associated with a selection of the plurality of selections;
determining a particular dwell time associated with the particular impression;
based on the particular dwell time, storing the second label in association with a particular training instance corresponding to the particular impression even though the particular impression is not associated with a selection.

10. The method of claim 8, further comprising:
storing view data that indicates, for each content item of a second plurality of content items, an amount of time that said each content item has been presented to a viewer;
storing second selection data that indicates, for each content item of the second plurality of content items, an indication of whether the viewer, to which said each content item was presented, performed a particular action relative to said each content item;
generating a curve that represents a probability of the particular action relative to the second plurality of content items given a lapse of time from presentation of each of the second plurality of content items;
based on the curve, identifying the bounce time that indicates a particular amount of time, below which it is presumed that future users, to which content items will be presented, are not interested in the content items.

11. The method of claim 8, further comprising:
in response to receiving a content request:
identifying a plurality of candidate content items and an entity that initiated the content request;
for each candidate content item in the plurality of candidate content items:
determining a prediction based on the selection prediction model and the entity;
generating a score based on the prediction;
selecting a particular content item from among the plurality of candidate content items based on the score generated for each candidate content item in the plurality of candidate content items;
causing the particular content item to be transmitted over a computer network in response to the content request.

12. The method of claim 11, further comprising:
storing a skip time that indicates a threshold period of time, wherein it is presumed that an entity skipped a content item if an amount of time that the entity is presented the content item is below the threshold period of time;
storing second impression data that indicates a second plurality of impressions of a second plurality of content items;
for each impression in the second plurality of impressions:
determining a particular dwell time associated with said each impression;
storing, in association with said each impression, a third label that indicates that a content item associated with said each impression is skipped if the particular dwell time is less than the skip time;
storing, in association with said each impression, a fourth label that indicates that the content item associated with said each impression is not skipped if the particular dwell time is greater than the skip time;
using one or more second machine learning techniques to train, based on the third and fourth labels associated with the second plurality of impressions, a skip prediction model;
for each candidate content item in the plurality of candidate content items:
determining a second prediction based on the skip prediction model and the entity;
wherein the score of said each candidate content item is further based on the second prediction.

13. The method of claim 12, further comprising:
storing viral selection data that indicates a plurality of viral selections of a second subset of the plurality of content items;
using one or more third machine learning techniques to train, based on the viral selection data, a viral prediction model;
for each candidate content item of the plurality of candidate content items:
generating a third prediction based on the viral prediction model;
generating an expected value, for a network of the entity, given a viral action;
generating a predicted value for the network of the entity based on the third prediction and the expected value;
wherein the score is further generated based on the predicted value.

14. The method of claim 13, further comprising:
for each candidate content item of the plurality of candidate content items:
generating a second expected value, for an author of said each candidate content item, given a viral action;
generating a second predicted value for the author of said each candidate content item based on the third prediction and the second expected value;
wherein the score is further generated based on the second predicted value.

15. A method comprising:
storing impression data that indicates a plurality of impressions of a plurality of content items, wherein each impression of the plurality of impressions indicates an impression of a content item of the plurality of content items;
generating a plurality of training instances based on the plurality of impressions, wherein each training instance of the plurality of training instances corresponds to a different impression of the plurality of impressions;
for each training instance of the plurality of training instances:
determining a dwell time that indicates an amount of time that a first content item associated with said each impression was presented to a viewer;
determining, based on the dwell time, a weight associated with the training instance;
using one or more first machine learning techniques to train, based on the plurality of training instances and the weight determined for each training instance, a prediction model;
wherein the method is performed by one or more computing devices.

16. The method of claim 15, further comprising:
in response to receiving a content request:
identifying a plurality of candidate content items and an entity that initiated the content request;
for each candidate content item in the plurality of candidate content items:
determining a prediction based on the prediction model and the entity;
generating a score based on the prediction;
selecting a particular content item from among the plurality of candidate content items based on the score generated for each candidate content item in the plurality of candidate content items;
causing the particular content item to be transmitted over a computer network in response to the content request.

17. The method of claim 15, further comprising
storing a skip time that indicates a threshold period of time, wherein it is presumed that a particular entity skipped a content item if a particular amount of time that the particular entity is presented the content item is below the threshold period of time;
storing second impression data that indicates a second plurality of impressions of a second plurality of content items;
for each impression in the second plurality of impressions:
determining a particular dwell time associated with said each impression;
storing, in association with said each impression, a first label that indicates that a content item associated with said each impression is skipped if the particular dwell time is less than the skip time;
storing, in association with said each impression, a second label that indicates that the content item associated with said each impression is not skipped if the particular dwell time is greater than the skip time;
using one or more second machine learning techniques to train, based on the first and second labels associated with the second plurality of impressions, a skip prediction model.

18. The method of claim 17, further comprising:
in response to receiving a content request:
identifying a plurality of candidate content items and an entity that initiated the content request;
for each candidate content item in the plurality of candidate content items:
determining a first prediction based on the prediction model and the entity;
determining a second prediction based on the skip prediction model and the entity;
generating a score based on the first prediction and the second prediction;
selecting a particular content item from among the plurality of candidate content items based on the score generated for each candidate content item in the plurality of candidate content items;
causing the particular content item to be transmitted over a computer network in response to the content request.

19. The method of claim 18, further comprising:
storing viral selection data that indicates a plurality of viral selections of a third plurality of content items;
using one or more third machine learning techniques to train, based on the viral selection data, a viral prediction model;
for each candidate content item of the plurality of candidate content items:
generating a third prediction based on the viral prediction model;
generating an expected value, for a network of the entity, given a viral action;
generating a predicted value for the network of the entity based on the third prediction and the expected value;
wherein the score is further generated based on the predicted value.

20. The method of claim 19, further comprising:
for each candidate content item of the plurality of candidate content items:
generating a second expected value, for an author of said each candidate content item, given a viral action;
generating a second predicted value for the author of said each candidate content item based on the second expected value;
wherein the score is further generated based on the second predicted value.
